(19) United States
(12) Patent Application Publication
(10) Pub. No.: US 2015/0343694 A1
(43) Pub. Date: Dec. 3, 2015

(54) Glossy Article

(71) Applicant: The Procter & Gamble Company, Cincinnati, OH (US)

(72) Inventors: Ping WANG, Beijing (CN); Liang YANG, Beijing (CN); Gaoyang WANG, Dongguan (CN); Dong RUAN, Beijing (CN)

(21) Appl. No.: 14/724,093

(22) Filed: May 28, 2015

(30) Foreign Application Priority Data
May 29, 2014 (CN) 2014/078792

(51) Int. Cl. B29C 49/06; C08L 67/02; B29C 49/08

(52) U.S. Cl. CPC B29C 49/06; B29C 49/08; C08L 67/02; B29K 2101/12

(57) ABSTRACT

A blow-molded article comprises a layer having two different thermoplastic materials, wherein the two thermoplastic materials have a Solubility Parameter difference of from about 0.1 cal^{1/2}cm^{-3/2} to about 20 cal^{1/2}cm^{-3/2}, and have a Refractive Index difference of from about 0.01 to about 1.5, and wherein the article is blow molded with a stretch ratio of about 4 to about 30. Such an article has a desirable glossy appearance.

### FIELD OF THE INVENTION

The present invention relates to a glossy blow molded article comprising a layer having a first thermoplastic material and a second, different thermoplastic material, and a process for making the article.

### BACKGROUND OF THE INVENTION

Articles, particularly containers, made of thermoplastic materials have been used to package a wide variety of consumer products, such as cosmetic, shampoo, laundry, and food. For such articles, having a glossy appearance is particularly appealing to users. A glossy effect or pearl-like luster effect or metallic luster effect tends to connote a premium product.

Traditionally there are various approaches to delivering a glossy effect to thermoplastic material articles. Specifically, additives such as pearlescent agents are known to be incorporated into the thermoplastic material to achieve the effect. Also, modifying the material per se or blow molding a blend of two or more thermoplastic materials can sometimes reach certain degree of glossiness. Another approach is to adhere a foil (e.g., aluminum foil, copper foil) onto the layer of thermoplastic material of an article, thereby providing a metallic effect.

Although many of the efforts in the art indeed achieve articles with improved glossiness, they pose challenges to mechanical properties of the obtained articles. For example, those approaches focusing on components (e.g., material blending or modification) typically require compatibility of the incorporated components because incompatibility can lead to decreased toughness of the obtained articles. In the container industry, toughness is a critical mechanical property that indicates quality of a blown container. Therefore, it is challenging to obtain an article having both desired glossiness and toughness.

Thus, there is a need to provide improved glossiness to articles made from two different thermoplastic materials, without compromising mechanical properties, particularly toughness, of the articles.

It is an advantage of the present invention to provide a glossy article minimizing expensive ingredients, e.g., pearlescent agents.

It is another advantage of the present invention to provide a process for manufacturing a glossy article from two different thermoplastic materials, without requiring a relatively high mold temperature.

It is yet another advantage of the present invention to provide a preform comprising two different thermoplastic materials, which is easy to blow thereby making a glossy article.

### SUMMARY OF THE INVENTION

In one aspect, the present invention is directed to a glossy blow molded article comprising a layer, wherein the layer comprises:

a) a first thermoplastic material having a Total Luminous Transmittance Value of at least 80%;

b) a second thermoplastic material different from the first thermoplastic material,

wherein the first thermoplastic material and the second thermoplastic material have: a Solubility Parameter difference from 0.1 cal^{1/2}cm^{-3/2} to 20 cal^{1/2}cm^{-3/2}, and a Refractive Index difference from 0.01 to 1.5,

wherein the article is blow molded with a stretch ratio of 4 to 30.

In another aspect, the present invention is directed to a process for making a glossy article, comprising the steps of:

a) mixing the aforementioned first thermoplastic material and second thermoplastic material to form a blow mold blend; and

b) blowing the blow mold blend in a mold with a stretch ratio of 4 to 30, thereby forming the glossy article.

In yet another aspect, the present invention is directed to a masterbatch for making the aforementioned glossy article, comprising:

a) a first thermoplastic material having a Total Luminous Transmittance Value of at least 80%; and

b) a second thermoplastic material different from the first thermoplastic material,

wherein the first thermoplastic material and the second thermoplastic material: have a Solubility Parameter difference of from 0.1 cal^{1/2}cm^{-3/2} to 20 cal^{1/2}cm^{-3/2}, and a Refractive Index difference of from 0.01 to 1.5, and the weight ratio of the first thermoplastic material to the second thermoplastic material in the masterbatch is: from 95:5 to 5:95.

In even yet another aspect, the present invention is directed to a preform for making the aforementioned glossy article, comprising a layer, wherein the layer comprises:

a) a first thermoplastic material having a Total Luminous Transmittance Value of at least 80%; and

b) a second thermoplastic material different from the first thermoplastic material,

wherein the first thermoplastic material and the second thermoplastic material: have a Solubility Parameter difference of from 0.1 cal^{1/2}cm^{-3/2} to 20 cal^{1/2}cm^{-3/2}, and a Refractive Index difference of from 0.01 to 1.5, and the weight ratio of the first thermoplastic material to the second thermoplastic material in the layer is: from 99:1 to 70:30, or from 1:99 to 30:70.

### BRIEF DESCRIPTION OF THE DRAWINGS

FIG. 1A is a Scanning Electron Microscope (SEM) image with 5,000 magnitude, showing a micro-structure formed in the container of Example 1A.

FIG. 1B is a SEM image with 30,000 magnitude of the container of Example 1A.

FIG. 2 is a SEM image with 5,000 magnitude of the container of Comparative Example 1E.

### DETAILED DESCRIPTION OF THE INVENTION

In the present invention, applicant has surprisingly found that an article with both improved glossiness and desired toughness is obtained, when the article is blow molded with a certain range of stretch ratio (namely, a stretch ratio of 4 to 30) by two different thermoplastic materials. Traditionally in a blow molding process, the stretch ratio of a blown article is maintained at a certain level (e.g., at around 3), as a higher stretch ratio is known to cause reduced toughness. However, in the present invention, it has been found that, this reduced toughness does not occur along with increased stretch ratio. Without wishing to be bound by theory, it is believed that the required stretch ratio, in combination with the particularly selected thermoplastic materials, leads to the formation of a micro-structure in the blown articles. The micro-structure delivers the improved glossiness, whilst enhancing the toughness of the articles and thereby offsetting the toughness reduction effect caused by increased stretch ratio.

In particular, the thermoplastic materials for making the article (the first and second thermoplastic materials) are intentionally selected to form the micro-structure. The first and second thermoplastic materials should meet certain requirements in terms of Solubility Parameter and Refractive Index, namely having: a Solubility Parameter difference from 0.1 cal^{1/2}cm^{-3/2} to 20 cal^{1/2}cm^{-3/2}, and a Refractive Index difference from 0.01 to 1.5. Without wishing to be bound by theory, it is believed that the required Solubility Parameter difference ensures that the thermoplastic materials are immiscible or at least partially immiscible with each other, and therefore immiscible domains of these materials form a micro-structure within the layer during stretch. In the blow molding process, the stretching of thermoplastic materials occurs during the step where the thermoplastic material admixture is expanded by air pressure against the surface of a mold. Also, a relatively large Refractive Index difference between the thermoplastic materials is required to allow more light to reflect and refract in the layer. The glossy effect is thus produced by light entering the micro-structure and reflecting and refracting within the structure when striking the micro-domains formed by the materials.

### DEFINITIONS

As used herein, the term “glossy” refers to a pearl-like luster effect or metallic luster effect. The measurement method for the glossiness (i.e., glossy effect) of an article is described below.

As used herein, the term “article” herein refers to an individual blow molded object for consumer usage, e.g., a shaver, a toothbrush, a battery, or a container suitable for containing compositions. Preferably the article is a container, non-limiting examples of which include a bottle, a tottle, a jar, a cup, a cap, and the like. The term “container” is used herein to broadly include elements of a container, such as a closure or dispenser of a container. The compositions contained in the container may be any of a variety of compositions including, but not limited to, detergents (e.g., laundry detergent, fabric softener, dish care, skin and hair care), beverages, powders, paper (e.g., tissues, wipes), beauty care compositions (e.g., cosmetics, lotions), medicinal, oral care (e.g., tooth paste, mouth wash), and the like. The container may be used to store, transport, or dispense compositions contained therein. Non-limiting volumes containable within the container are from 10 ml to 5000 ml, alternatively from 100 ml to 4000 ml, alternatively from 500 ml to 1500 ml, alternatively 1000 ml to 1500 ml.

As used herein, the term “blow mold” refers to a manufacturing process by which hollow cavity-containing plastic articles, preferably containers suitable for containing compositions, are formed. In general, there are three main types of blow molding: extrusion blow molding (EBM), injection blow molding (IBM), and injection stretch blow molding (ISBM). The blow molding process typically begins with shearing or melting plastic and forming it into an article precursor having a closed tube-like structure with a single opening in one end of the structure which air can pass into. The term “article precursor”, as used herein, refers to the intermediate product form of plastic that is affixed into a blow molding mold and blown with air so as to expand against the inner surface of the mold to form the final article. The article precursor is typically either an extruded parison or an injected preform, depending on how it is made. The melted or heated article precursor (e.g., the injection molded preform) is then fixed into a mold, and its opening is blown with compressed air. The air pressure stretches and blows the plastic out to conform to the shape of the mold. Once the plastic has cooled, the mold opens and the formed article is ejected. In one preferred embodiment, the article is injection stretch blow molded, preferably is an injection stretch blow molded container.

As used herein, the term “stretch ratio” means the ratio of the size of a post-blown article (e.g., container) relative to that of its pre-blown article precursor (e.g., preform or parison), i.e., the ratio of the size of the article before and after the blowing step. The calculation method of the stretch ratio is described below.

As used herein, the term “transmittance” refers to the percentage of transmitted light to incident light. One way to characterize the transmittance of a material is the parameter “Total Luminous Transmittance (Tt)”. The Tt is tested according to ASTM D-1003 “Standard Test Method for Haze and Luminous Transmittance of Transparent Plastics”. A sample thickness of 0.8 mm and a tungsten lamp light source are used for the Tt measurement herein.

As used herein, the term “Solubility Parameter (δ)” provides a numerical estimate of the degree of interaction between materials. A Solubility Parameter difference between materials indicates miscibility of the materials. For example, materials with similar δ values are likely to be miscible, and materials having a larger δ difference tend to be more immiscible. The Hildebrand Solubility Parameter is used herein for purposes to characterize a material's δ. The calculation method of the Hildebrand δ and the δ data of certain example materials are described below.

As used herein, the term “Refractive Index (RI)” means a ratio of the speed of light in vacuum relative to that in another medium. RI (nD25) data is used herein, where nD25 refers to the RI tested at 25° C. and D refers to the D line of the sodium light. The calculation method of the RI (nD25) and the RI (nD25) data of certain example materials are described below.

As used herein, the term “toughness” refers to the ability of a material or an article to absorb energy and plastically deform without breaking. The toughness of an article herein is characterized by Elongation at break (normalized by sample thickness), which is tested according to ASTM D-638 “Standard Test Method for Tensile Properties of Plastics” as described below.

As used herein, the term “micro-structure” refers to the micro-domains formed by the aforementioned thermoplastic materials in one macro-layer of the article. The micro-domains of the materials, is on a nano-scale, preferably from about 1-5 nanometers to about 100-1000 nanometers. In the execution where one type of thermoplastic material is preponderant in the layer in terms of weight percentage, the other minor thermoplastic material(s) forms micro-domains interspersed in the matrix of the preponderant thermoplastic material. The micro-domains of the minor thermoplastic material(s) can be in the form of a whole coherent piece, or can be in the form of a number of segregated pieces.

As used herein, the term “layer” means a macro-scale layer of the material forming an article, as opposed to the nano-scale micro-layers in the above mentioned micro-structure. Typically, the macro-scale layer has a thickness of from about 0.01 mm to about 10 mm, alternatively from about 0.1 mm to about 5 mm, alternatively from about 0.2 mm to about 1 mm.

As used herein, the term “processing temperature” refers to the temperature of the mold cavity during the blow step of a blow molding process. During the blow step, the temperature of the material will eventually approach the temperature of the mold cavity, i.e., the processing temperature. The processing temperature is typically higher than the melting point of the material. Different thermoplastic materials typically require different processing temperatures, depending on factors including: melting point of the material, blow molding type, etc. The processing temperature is much higher than the mold temperature which is typically from about 10 to 30° C. Thus, when the material is expanded by air pressure against the surface of the mold, the material is cooled by the mold and finally achieves a temperature equal to or slightly higher than the mold temperature.

As used herein, when a composition is “substantially free” of a specific ingredient, it is meant that the composition comprises less than a trace amount, alternatively less than 0.1%, alternatively less than 0.01%, alternatively less than 0.001%, by weight of the composition of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Glossy Article

The glossy article of the present invention is blow molded with a stretch ratio of 4 to 30 and comprises a layer that comprises a first and second thermoplastic materials as described herein. Preferably, the stretch ratio is from 4 to 15, more preferably from 5 to 10, even more preferably from 6 to 8.

In terms of glossiness, the article of the present invention preferably delivers an improved glossy effect over those articles made of one thermoplastic material or stretched with a relatively low stretch ratio (e.g., a stretch ratio of 3). In one embodiment, the article herein has a Glossiness Value of from 90 to 150, alternatively from 100 to 145, alternatively from 110 to 140, according to the test method for glossiness as described below. In terms of smoothness, the article of the present invention preferably has a Roughness Value (Ra) of from about 0.90 nm to about 5 nm, alternatively from about 0.95 nm to about 4 nm, alternatively from 0.98 nm to about 3 nm, according to the test method for smoothness as described below in the present invention.

Preferably, the glossy article herein demonstrates comparable toughness over those articles blow molded at a relatively low stretch ratio. In one embodiment, the article has an Elongation at break Value of from 0.6 to 5, preferably from 0.7 to 3, alternatively from 1.0 to 2.5, according to the test method for toughness as described below.

The article herein can comprise one single layer or multiple layers. In a single layer execution, the first and second thermoplastic materials as described herein are contained in this single layer of the article. Alternatively, in a multiple-layer execution, the article herein comprises multiple layers, wherein at least one layer of the multiple layers comprises the first and second thermoplastic materials as described herein. In one embodiment, the one layer comprising the first and second thermoplastic materials as described herein is in the outermost layer of the multiple layers. As such, the glossy appearance is visible to a user when viewing the article, e.g., on a store shelf. For example, the article may be a two-layer article of polyethylene terephthalate/polyethylene (PET/PE) wherein the PET is the outer layer, and a second material, polymethyl methacrylate (PMMA), is present in the outer PET layer. In an alternative example, the one layer comprising the first and second thermoplastic materials as described herein is in an inner layer of the multiple layers, and the outermost layer is transparent or at least substantially transparent or translucent, and so the glossy appearance is visible to a user by looking through the transparent or translucent outermost layer to the inner glossy layer of the article. The term “inner layer” herein refers to the layer of the article that typically does not make contact with a user during usage. In a container execution, the inner layer is in nearer proximity to the composition contained in the article than the outer layer and may make contact with the contained composition.

### Thermoplastic Material

The glossy article of the present invention comprises a layer, and the layer comprises a first thermoplastic material having a Total Luminous Transmittance Value of at least 80%, and a second thermoplastic material different from the first thermoplastic material. The first and second thermoplastic materials have: a Solubility Parameter difference from 0.1 cal^{1/2}cm^{-3/2} to 20 cal^{1/2}cm^{-3/2}, and a Refractive Index difference from 0.01 to 1.5. Preferably, the first and second thermoplastic materials have: a Solubility Parameter difference from 0.3 cal^{1/2}cm^{-3/2} to 10 cal^{1/2}cm^{-3/2}, and a Refractive Index difference from 0.03 to 1.0.

The first and second thermoplastic materials can be present at any suitable levels in the layer. Preferably, one of the thermoplastic materials is preponderant in the layer, rather than having the two thermoplastic materials present at the same level. It has been found that an article comprising a layer that comprises the two thermoplastic materials at the same level (e.g., the weight ratio of the two thermoplastic materials is 50:50) is not as glossy as those having a preponderant material. Without wishing to be bound by theory, it is believed that in the preponderant execution, the micro-structure is easier to form since the minor thermoplastic material can form micro-domains interspersed in the matrix of the preponderant thermoplastic material. In one embodiment, the weight ratio of the first thermoplastic material to the second thermoplastic material in the layer is from 99:1 to 70:30, or from 1:99 to 30:70. Preferably, the weight ratio of the first thermoplastic material to the second thermoplastic material in the layer is from 95:5 to 80:20, or from 5:95 to 20:80. More preferably, the first thermoplastic material is present at a higher level in the layer than the second thermoplastic material. In one embodiment, the weight ratio of the first thermoplastic material to the second thermoplastic material in the layer is from 99:1 to 70:30, preferably from 95:5 to 80:20, more preferably from 95:5 to 85:15.

In one embodiment, the first and second thermoplastic materials have a glass transition temperature (Tg) difference. Preferably, the Tg difference between the two is at least 3° C., preferably from 3° C. to 90° C., alternatively from 5° C. to 70° C., alternatively from 10° C. to 50° C., alternatively from 15° C. to 40° C. Either the first or the second thermoplastic material can have the higher Tg, but preferably the second thermoplastic material has a higher Tg, especially in the execution where the first thermoplastic material is preponderant in the layer. For example, in a layer of the article according to the present invention, the first thermoplastic material is polyethylene terephthalate (PET) that has a Tg of 70° C. and is present at 90%, by weight of the layer, in the layer, and the second thermoplastic material is polymethyl methacrylate (PMMA) that has a Tg of 105° C. and is present at 10%, by weight of the layer, in the layer. Without wishing to be bound by theory, it is believed that when the preponderant first thermoplastic material has a lower Tg, it melts earlier during the step of forming an article precursor or the blowing step of forming the article, and therefore provides a molten matrix that facilitates the dispersion of micro-domains of the minor second thermoplastic material that melts later. Thus, a more uniform micro-structure is formed in the layer and enables further improved glossiness and toughness.

The first and second thermoplastic materials can be selected from any suitable thermoplastic materials as long as they meet the aforementioned requirements in terms of Solubility Parameter and Refractive Index. The Solubility Parameter and Refractive Index values of various thermoplastic materials are available in the art, and the values of certain example materials are described below.

In one embodiment, the first thermoplastic material is selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBT), acrylonitrile styrene (AS), styrene butadiene copolymer (SBC), and a combination thereof. Preferably the first thermoplastic material is selected from the group consisting of PET, PETG, PEN, PS, and a combination thereof. More preferably, the first thermoplastic material is PET.

In one embodiment, the second thermoplastic material is selected from the group consisting of PMMA, polyethyl methacrylate, polybutyl methacrylate, polyhexyl methacrylate, poly 2-ethylhexyl methacrylate, polyoctyl methacryalte, polylactide (PLA), ionomer of poly(ethylene-co-methacrylic acid) (e.g., Surlyn® commercially available from DuPont), cyclic olefin polymer (COP), and a combination thereof. Preferably the second thermoplastic material is selected from the group consisting of PMMA, PLA, and a combination thereof. More preferably, the second thermoplastic material is PMMA.

Recycled thermoplastic materials can be used in the present invention, e.g., post-consumer recycled polyethylene terephthalate (PCRPET); post-industrial recycled polyethylene terephthalate (PIR-PET); regrind polyethylene terephthalate. The article made from the thermoplastic material can be recyclable as well.

The thermoplastic material herein may be formed by using a combination of monomers derived from renewable resources and monomers derived from non-renewable (e.g., petroleum) resources. For example, the thermoplastic material may comprise polymers made from bio-derived monomers in whole, or comprise polymers partly made from bio-derived monomers and partly made from petroleum-derived monomers.

In one preferred embodiment, the glossy article of the present invention comprises a layer, wherein the layer comprises: from 85% to 95%, by weight of the layer, of PET having a Total Luminous Transmittance Value of at least 80%; and from 5% to 15%, by weight of the layer, of PLA, wherein the article is injection stretch blow molded with a stretch ratio of 5 to 10.

In an alternative preferred embodiment, the glossy article of the present invention comprises a layer, wherein the layer comprises: from 85% to 95%, by weight of the layer, of PET having a Total Luminous Transmittance Value of at least 80%; and from 5% to 15%, by weight of the layer, of PMMA, wherein the article is injection stretch blow molded with a stretch ratio of 5 to 10.

### Adjunct Ingredient

The article of the present invention may comprise an adjunct ingredient. Preferably, the adjunct ingredient is present in an amount of from about 0.0001% to about 9%, alternatively from about 0.0001% to about 5%, alternatively from about 0.0001% to about 1%, by weight of the one layer of the article, of the adjunct ingredient. Non-limiting examples of the adjunct ingredient include: a third thermoplastic material that is different from the aforementioned first and second thermoplastic materials, pearlescent agent, filler, cure agent, anti-statics, lubricant, UV stabilizer, anti-oxidant, anti-block agent, catalyst stabilizer, colorant, nucleating agent, and a combination thereof. In the execution where the third thermoplastic material is present, the third thermoplastic material does not have to satisfy the aforementioned requirements in terms of Solubility Parameter and Refractive Index. Alternatively, the article is substantially free of one or more of these adjunct ingredients.

The article herein may or may not comprise a pearlescent agent. The term “pearlescent agent” herein refers to a chemical compound or a combination of chemical compounds of which the principle intended function is to deliver a pearlescent effect to an article.

The pearlescent agent herein could be any suitable pearlescent agents, preferably is selected from the group consisting of mica, SiO₂, Al₂O₃, glass fiber and a combination thereof. In one embodiment, few amounts of pearlescent agents are used because the present invention provides a glossy effect. For example, the article comprises less than about 0.5%, alternatively less than about 0.1%, alternatively less than about 0.01%, alternatively less than about 0.001%, by weight of the layer, of the pearlescent agent. Preferably, the article is substantially free of a pearlescent agent. Without the incorporation of pearlescent agents or minimizing the amounts of pearlescent agents, the glossy article of the present invention avoids the negative impact of pearlescent agents on the surface smoothness of a article and the recycling issue that the pearlescent agents might have caused. Moreover, particularly in the present invention, the addition of pearlescent agents would disturb the light interference effect rendered by the micro-layering structure, thus adversely affecting the glossy effect.

The article herein may or may not comprise a nucleating agent. Specific examples of the nucleating agent include: benzoic acid and derivatives (e.g., sodium benzoate and lithium benzoate), talc and zinc glycerolate, organocarboxylic acid salts, sodium phosphate and metal salts (e.g., aluminum dibenzoate). The addition of the nucleating agent could improve the tensile and impact properties of the article. But in the present invention, since desired toughness is already obtained, the article could be substantially free of a nucleating agent, alternatively less than about 0.1%, alternatively less than about 0.01%, alternatively less than about 0.001%, by weight of the layer, of the nucleating agent.

### Process of Making the Article

One aspect of the present invention is directed to a process for making a glossy article, comprising the steps of:

a) mixing a first thermoplastic material having Total Luminous Transmittance Value of at least 80% and a second, different thermoplastic material to form a blow mold blend,

wherein the first thermoplastic material and the second thermoplastic material have: a Solubility Parameter difference from 0.1 cal^{1/2}cm^{-3/2} to 20 cal^{1/2}cm^{-3/2}, and have a Refractive Index difference of from about 0.01 to about 1.5; and

b) blowing the blow mold blend obtained in step a) in a mold with a stretch ratio of 4 to 30 to form the article. The stretch ratio is preferably 4 to 15, more preferably 5 to 10, even more preferably 6 to 8.

In the execution where one type of thermoplastic material is preponderant in the layer, in step a), the minor thermoplastic material is preferably first combined with a carrier to form a masterbatch. The masterbatch is preferably formed by: mixing the minor thermoplastic material and the carrier under ambient temperature; extruding the mixture of the minor thermoplastic material and the carrier in an extruder (e.g., a twin screw extruder) to form pellets; and then cooling the pellets in a water bath to form the masterbatch. Then, the masterbatch is mixed with the preponderant thermoplastic material to form the blow mold blend, i.e., the minor thermoplastic material is added into the preponderant thermoplastic material via a masterbatch. The masterbatch may comprise certain adjunct ingredients (e.g., colorants). For example, the masterbatch is typically a color masterbatch used for providing color to an article. The carrier herein may be a different material from the preponderant thermoplastic material or the same material as the preponderant thermoplastic material. Preferably the carrier is the same material as the preponderant thermoplastic material, thereby reducing the number of types of thermoplastic material in the article and allowing ease and efficiency of recycling.

Alternatively, in step a), the first and second thermoplastic materials are combined directly, i.e., without forming a masterbatch. The combination of the first and second thermoplastic materials is preferably uniformly mixed to form the blow mold blend.

In step b), blowing the blow mold blend can be conducted by any known blow molding processes, preferably by EBM, IBM, or ISBM, more preferably by ISBM. In one embodiment, the above blow mold blend is sheared, preferably sheared and heated, in a barrel at a screw speed of 20 to 60 rpm, preferably 30 to 50 rpm, more preferably 36 to 44 rpm, to provide a molten blow mold blend. In the present invention, it has been surprisingly found that a relatively low screw speed in the barrel leads to improved glossiness. Without wishing to be bound by theory, it is believed that such a relatively low screw speed minimizes the damage to the structure of thermoplastic materials and therefore facilitates the formation of the micro-structure, which further leads to the glossiness effect. In the ISBM process the molten blow mold blend is subsequently injection molded to form a preform, while in the EBM process the molten blow mold blend is then extruded to form a parison. The preform or parison is then blown in a mold to form the final article.

In one embodiment, the process herein further comprises the step of cooling the blown article. In the blow molding process, there is typically a sharp drop in the material temperature when the material touches the mold. Typically, the material temperature is around the processing temperature, and the mold temperature is typically below 50° C. Thus, the material is cooled by the mold and finally achieves a temperature equal to or slightly higher than the mold temperature. In the art, a higher mold temperature (e.g., 40° C. to 60° C.) is typically utilized to improve glossiness of blown articles. By contrast, in the present invention, since a glossy effect is already achieved by stretching the selected thermoplastic materials with a certain stretch ratio, such a high mold temperature is not necessary. The mold temperature in the present invention is about 10 to 30° C. and thus significantly saves cost to industrial production. Moreover, since the higher mold temperature in the art negatively affects the formability of blown articles (i.e., the blown articles are not of a well-molded shape), the lower mold temperature of the present invention allows for improved processing formability.

In one aspect, the present invention is directed to a masterbatch for making a glossy article, comprising the aforementioned first and second thermoplastic materials. Preferably the weight ratio of the first thermoplastic material to the second thermoplastic material in the masterbatch is: from 95:5 to 5:95. In the execution where one type of thermoplastic material is preponderant in the blown article, the masterbatch for making the article comprises from 10% to 50%, preferably 20% to 40%, by weight of the masterbatch, of the minor thermoplastic material. Preferably the second thermoplastic material is the minor one.

In yet another aspect, the present invention is directed to a preform for making a glossy article, comprising a layer, wherein the layer comprises the aforementioned first and second thermoplastic materials. Preferably the weight ratio of the first thermoplastic material to the second thermoplastic material in the layer of the preform is: from 99:1 to 70:30, or from 1:99 to 30:70. In the present invention, applicant has surprisingly found that such a preform having a preponderant thermoplastic material and a minor thermoplastic material demonstrates improved blowdability to further make an article. Without wishing to be bound by theory, it is believed that the preponderant thermoplastic material functions as a coherent matrix for the dispersion of the minor thermoplastic material and this matrix facilitates easy blowing. By contrast, in the equal-present execution, such a coherent matrix does not exist in a preform, causing the difficulty in blowing the preform.

In a multi-layer execution, the article comprising multiple layers is made from multiple layer preform or parison.

### Parameters

Solubility Parameter

The Hildebrand δ is the square root of the cohesive energy density, as calculated by:

$$δ = \sqrt{\frac{Δ {H}_{v} - RT}{{V}_{m}}} \qquad ( 1 )$$

wherein the cohesive energy density is equal to the heat of vaporization (ΔHᵥ) divided by molar volume (Vₘ), R is the gas constant (8.314 J·K⁻¹mol⁻¹), and T is absolute temperature.

The δ data of various thermoplastic materials can be calculated by the above method and is readily available from books and/or online databases. The δ values of certain preferred thermoplastic materials are listed in Table 1.

Refractive Index

The Refractive Index is calculated as:

$$n = \frac{c}{v} \qquad ( 2 )$$

wherein c is the speed of light in vacuum and v is the speed of light in the substance.

The RI (nD25) data of various thermoplastic materials can be calculated by the above method and is readily available from books and/or online RI databases. The RI (nD25) values of certain preferred thermoplastic materials are listed in Table 1.

TABLE 1

| Substance | Hildebrand δ (cal^{1/2}cm^{-3/2}) | Refractive index |
|---|---|---|
| PET | 10.7 | 1.57 |
| PMMA | 9.3 | 1.49 |
| PS | 9.11 | 1.589 |
| PC | 9.6 | 1.586 |
| PLA | 10 | 1.45 |
| COP | 8.5 | 1.525 |
| Surlyn ® ₐ | 9 | 1.51 |

ₐ Surlyn ® is an ionomer of poly(ethylene-co-methacrylic acid), under the name of PC-2000 from Du Pont commercially available from DuPont

Stretch Ratio

The stretch ratio of an article is calculated as:

Stretch Ratio=Axial stretch*Hoop stretch (3)

Both the terms “axial stretch” and “hoop stretch” herein refer to certain parameters of a blown article in view of the article precursor that is blow molded to obtain the article (e.g., parison or preform). Specifically, the axial stretch is calculated by dividing the height of the article by the height of the preform or parison, and the hoop stretch is calculated by dividing the inner diameter of the article at middle height by the average inner diameter of the preform or parison at middle height. In an ISBM execution where a preform is stretch blow molded, both the axial stretch and hoop stretch are greater than 1 since the preform is stretched both vertically and horizontally, while in an EBM execution where a parison is blow molded, the axial stretch is typically equal to 1 since the parison is stretched only horizontally.

### Test Method

Glossiness

An active polarization camera system called SAMBA is used to measure the specular glossiness of the present article. The system is provided by Bossa Nova Technologies and a polarization imaging software named VAS (Visual Appearance Study software, version 3.5) is used for the analysis. The front labeling panel part of the article is tested against an incident light. An exposure time of 55 sec is used.

The incident light is reflected and scattered by the article. The specular reflected light keeps the same polarization as the incident light and the volume scattered light becomes un-polarized. SAMBA acquires the polarization state of a parallel image intensity (P) contributed by both the reflected and scattered light, and a crossed image intensity (C) of the image contributed only by the scattered light. This allows the calculation of glossiness G given by G=P−C.

Smoothness

The surface smoothness of an article can be characterized by Roughness. The roughness is measured by Atomic Force Microscope (AFM). The AFM supplied by Veeco is used herein. It is set at a contact mode for the roughness measurement. The detection area is on the center of the front labeling panel area of the article. An area of 580 nm×580 nm is used and data is collected as the average value of 10 spots within the detection area.

Roughness measured in nm from AFM measurement can be represented by arithmetic mean value (Ra) of the absolute height yi in vertical direction at specific position i. Ra is represented as:

$${R}_{a} = \frac{1}{n} {\sum }_{i = 1}^{n} \vert {y}_{i} \vert \qquad ( 3 )$$

The Ra value increases with the roughness.

Toughness

The toughness of an article can be characterized by Elongation at break, which is the ratio between elongated length and initial length of a sample when it breaks. In the present invention, the Elongation at break is tested according to the method ASTM D-638. In the test, electromechanical testing machine 5565H1596 commercially available from Instron is used. The test is conducted under a temperature of 60° C. and at a stretch speed of 100 mm/min. In particular, since the thickness of a sample also affects the Elongation at break, the Elongation at break Value used in the present invention is normalized by sample thickness, namely, dividing the value obtained from the testing machine by sample thickness.

Micro-Structure

The micro-structure formed in the article of the present invention can be observed via Scanning Electron Microscope (SEM) by scanning of the cross-section view of the article microscopically. A HITACHI S-4800 SEM system is used herein.

### EXAMPLE

The Examples herein are meant to exemplify the present invention but are not used to limit or otherwise define the scope of the present invention. Examples 1A-1C and 2-7 are examples according to the present invention, and Examples 1D-1E are comparative Examples.

### Examples 1A-1E

### Blow Molded Containers

The following containers shown in Table 2 are made of the listed ingredients in the listed proportions (weight %) and are stretch blow molded with the indicated stretch ratio.

TABLE 2

| | 1A | 1B | 1C | Comparative 1D | Comparative 1E |
|---|---|---|---|---|---|
| PET a | 90 | 90 | 90 | 90 | 100 |
| PMMA b | 10 | 10 | 10 | 10 | 0 |
| Stretch ratio | 4 | 6 | 8 | 3 | 4 |

a commercially available under the name of CB-602 from Far Eastern Industries (Shanghai) Ltd. It has a Tt of 90%.
b commercially available under the name of CM-211 from Chi Mei Corporation.

Processes for making the container of Example 1A

The container of Example 1A is manufactured by the following steps:

a) adding PMMA into a carrier of PET under ambient temperature to form a mixture, and then extruding the mixture of PMMA and PET in a twin screw extruder at a temperature of 200° C. to form pellets. Cooling the pellets in a water batch at about 20° C. for 0.5 min to form a masterbatch. The PMMA is present in an amount of 40% by weight of the masterbatch. The twin screw extruder has an extruder length/diameter (L/D) of 43 and diameter of 35.6 mm;

b) drying the masterbatch and extra PET for 3-4 hours, separately, under 120-125° C. Mixing the dried masterbatch and dried extra PET at a let-down ratio of 25% under ambient temperature to form a blow mold blend;

c) shearing and heating the blow mold blend in a barrel at a screw speed of 40 rpm to provide a molten blow mold blend. Then injection molding the molten blow mold blend into a preform, under a temperature of 260° C., under an injection pressure of 70-80 MPa, and at an injection speed of 60-70 mm/s; and

d) Heating and softening the preform with an infrared heating machine at 70-90° C. for about 2 minutes. Affixing the softened preform into a stretch blow molding mold, and then blowing into the preform with air under a blowing pressure of 2.5-3.5 Mpa, at a processing temperature of 260° C., and at a stretch ratio of 4, by using a blow machine Type CP03-220 from Guangzhou Rijing Automation Machinery Co., Ltd. The air pushes the preform to expand against the inner surface of the mold. The mold temperature is 25° C., and the blown container is cooled by the mold at a cooling rate of 25° C./sec. Ejecting the blown container out of the mold after it is cooled down,

wherein in the blow mold blend, each ingredient is present in the amount as specified for Example 1A in Table 2.

Processes of Making the Containers of Examples 1B-1E

The containers of Examples 1B-1C are manufactured by the same steps as making the container of Example 1A, except for that in step d) the stretch ratio is 6 and 8, respectively.

The container of Comparative Example 1D is manufactured by the same steps as making the container of Example 1A, except for that in step d) the stretch ratio is 3.

The container of Comparative Example 1E is manufactured by the same steps as making the container of Example 1A, except for that the specific type of thermoplastic material and the amount thereof are different, as specified for Example 1E in Table 2.

### Examples 2-7

### Blow Molded Containers

The following containers shown in Table 3 are made of the listed ingredients in the listed proportions (weight %) and are stretch blow molded with the indicated stretch ratio.

TABLE 3

| | 2 | 3 | 4 | 5 | 6 | 7 |
|---|---|---|---|---|---|---|
| PET a | 50 | 0 | 0 | 90 | 0 | 90 |
| PETG b | 0 | 90 | 0 | 0 | 0 | 0 |
| PS c | 0 | 0 | 90 | 0 | 90 | 0 |
| PMMA d | 50 | 10 | 10 | 0 | 0 | 0 |
| PLA e | 0 | 0 | 0 | 10 | 0 | 0 |
| Surlyn ® f | 0 | 0 | 0 | 0 | 10 | 0 |
| COP g | 0 | 0 | 0 | 0 | 0 | 10 |
| Stretch ratio | 4 | 4 | 4 | 4 | 4 | 4 |

a commercially available under the name of CB-602 from Far Eastern Industries (Shanghai) Ltd. It has a Tt of 90%.
b commercially available under the name of Eastar GN071 from Eastman.
c commercially available under the name of Polyrex PG33 from Chi Mei Corporation.
d commercially available under the name of CM-211 from Chi Mei Corporation.
e commercially available under the name of Revode 201 from Zhejiang Hisun Biomaterials Co., Ltd.
f commercially available under the name of PC-2000 from Du Pont.
g commercially available under the name of Zeonor 1060R from Nippon Zeon.

Processes of Making the Containers of Example 2-7

The containers of Examples 2-7 are manufactured by the same steps as making the container of Example 1A, except for that the specific types of thermoplastic materials and the amounts thereof are different, as specified for Examples 2-7 in Table 3.

In particular, it has been found that the preform in Example 2 is difficult to blow to make an article. As discussed previously, this might be due to the equal level of PET and PMMA in the blow mold blend and preform.

Comparative Data of Examples 1 and 2 on Glossiness and Toughness

Comparative experiments of assessing the glossiness and toughness of containers of Examples 1A-1C and Comparative Example 1D are conducted. The glossiness is measured according to the method for glossiness as described hereinabove and characterized as a Glossiness Value. The toughness is measured according to the method for toughness as described herein and characterized as Elongation at break Value. Samples are taken from the neck portion of the containers, each having a length of 40 mm and a width of 10 mm. The thicknesses of the samples from the containers of Examples 1A-1D are 1.8 mm, 1.3 mm, 1.1 mm, and 0.4 mm, respectively. Table 4 below demonstrates the Glossiness Values and Elongation at break Values (normalized by sample thickness) of the containers.

TABLE 4

| | 1A | 1B | 1C | Comparative 1D |
|---|---|---|---|---|
| Glossiness | 130 | 130 | 142 | 77 |
| Elongation at break/%/mm | 0.7 | 1.7 | 1.4 | 0.45 |

As shown in Table 4, the containers according to the present invention (Examples 1A-1C), which are blow molded with a stretch ratio of 4, 6, and 8, respectively, demonstrate significantly improved glossiness and toughness. By contrast, the container of comparative example (Example 1D), which has a lower stretch ratio (a stretch ratio of 3), shows much lower values in terms of both glossiness and toughness.

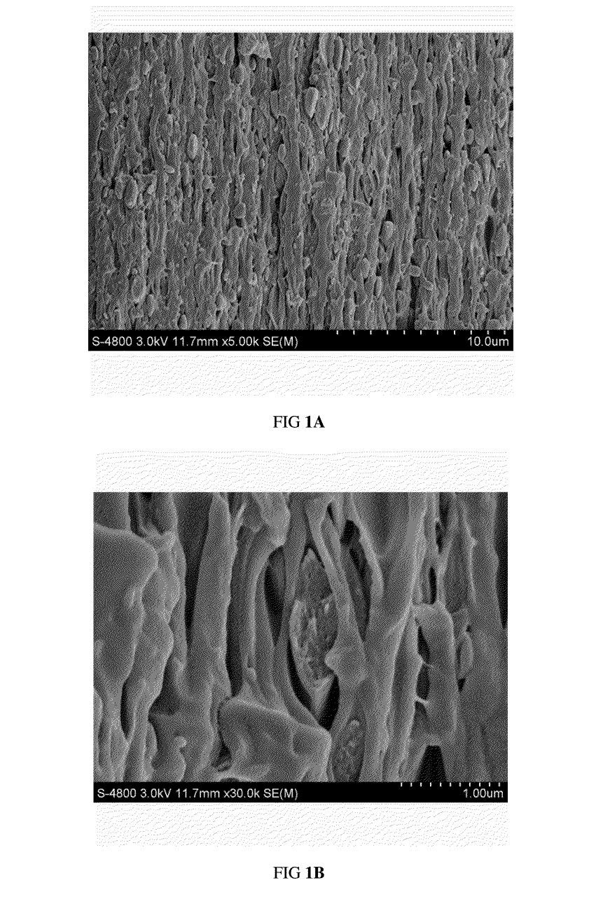

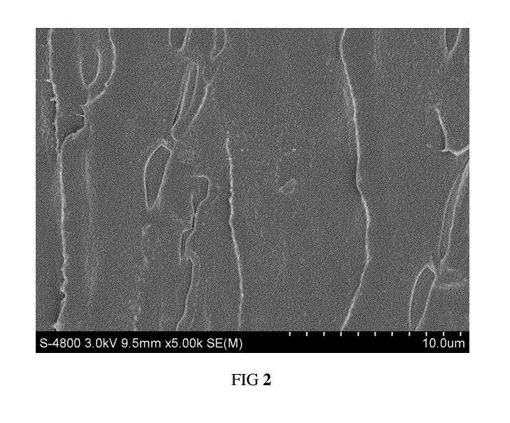

Moreover, the containers of Examples 1A and 1E are scanned via a HITACHI S-4800 SEM system to illustrate the micro-structure thereof. Specifically, samples for scanning are taken from the middle portion of the containers (i.e., at the half height of the containers). FIGS. 1A and 1B show the SEM images of the container of Example 1A, in which a micro-structure, particularly the interspersed micro-domains, is clearly observed. By contrast, in the SEM image of the container of Comparative Example 1E, as shown in FIG. 2, no such micro-structure is observed.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A glossy blow molded article, comprising a layer, wherein said layer comprises:
a) a first thermoplastic material having a Total Luminous Transmittance Value of at least about 80%; and
b) a second thermoplastic material different from said first thermoplastic material,
wherein said first thermoplastic material and said second thermoplastic material have: a Solubility Parameter difference from about 0.1 cal^{1/2}cm^{-3/2} to about 20 cal^{1/2}cm^{-3/2}, and a Refractive Index difference from about 0.01 to about 1.5,
wherein the article is blow molded with a stretch ratio of about 4 to about 30.

2. The article according to claim 1, wherein the weight ratio of said first thermoplastic material to said second thermoplastic material in said layer is: from 95:5 to about 80:20, or from about 5:95 to about 20:80.

3. The article according to claim 2, wherein the weight ratio of said first thermoplastic material to said second thermoplastic material in said layer is from about 95:5 to about 85:15.

4. The article according to claim 1, wherein the article is blow molded with a stretch ratio of about 5 to about 10.

5. The article according to claim 1, wherein said first thermoplastic material and said second thermoplastic material have a glass transition temperature (Tg) difference from 3° C. to 90° C.

6. The article according to claim 1, wherein said first thermoplastic material is selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBT), acrylonitrile styrene (AS), styrene butadiene copolymer (SBC), and a combination thereof.

7. The article according to claim 1, wherein said second thermoplastic material is selected from the group consisting of polymethyl methacrylate (PMMA), polyethyl methacrylate, polybutyl methacrylate, polyhexyl methacrylate, poly 2-ethylhexyl methacrylate, polyoctyl methacryalte, polylactide (PLA), ionomer of poly(ethylene-co-methacrylic acid), cyclic olefin polymer (COP), and a combination thereof.

8. The article according to claim 1, wherein the article has a Glossiness Value of from about 90 to about 150.

9. The article according to claim 1, wherein said article is a container and said article is injection stretch blow molded.

10. The article according to claim 1, comprising less than about 0.1%, by weight of said layer, of a pearlescent agent.

11. The article according to claim 1, wherein said layer comprises:
a) from about 85% to about 95%, by weight of said layer, of PET having a Total Luminous Transmittance Value of at least about 80%; and
a) from about 5% to about 15%, by weight of said layer, of PMMA,
wherein the article is injection stretch blow molded with a stretch ratio of about 5 to about 10.

12. A process for making the glossy article according to claim 1, comprising the steps of:
a) mixing said first thermoplastic material and said second thermoplastic material to form a blow mold blend; and
b) blowing said blow mold blend in a mold with a stretch ratio of about 4 to about 30 to form the article.

13. The process according to claim 12, wherein step b) is carried out by shearing said blow mold blend at a screw speed of about 20 to about 60 rpm to provide a molten blow mold blend, injection molding or extruding said molten blow mold blend to provide a preform or parison, and then blowing said preform or parison to form the article.

14. A masterbatch for making the glossy article according to claim 1, comprising:
a) a first thermoplastic material having a Total Luminous Transmittance Value of at least about 80%; and
b) a second thermoplastic material different from said first thermoplastic material,
wherein said first thermoplastic material and said second thermoplastic material: have a Solubility Parameter difference of from about 0.1 cal^{1/2}cm^{-3/2} to about 20 cal^{1/2}cm^{-3/2}, and a Refractive Index difference of from about 0.01 to about 1.5, and the weight ratio of said first thermoplastic material to said second thermoplastic material in the masterbatch is: from about 95:5 to about 5:95.

15. A preform for making the glossy article according to claim 1, comprising a layer, wherein said layer comprises:
a) a first thermoplastic material having a Total Luminous Transmittance Value of at least about 80%; and
b) a second thermoplastic material different from said first thermoplastic material,
wherein said first thermoplastic material and said second thermoplastic material: have a Solubility Parameter difference of from about 0.1 cal^{1/2}cm^{-3/2} to about 20 cal^{1/2}cm^{-3/2}, and a Refractive Index difference of from about 0.01 to about 1.5, and the weight ratio of said first thermoplastic material to said second thermoplastic material in said layer is: from about 99:1 to about 70:30, or from about 1:99 to about 30:70.
